(19) United States
(12) Patent Application Publication
(10) Pub. No.: US 2008/0042313 A1
(43) Pub. Date: Feb. 21, 2008

(54) Molded composite manufacturing process

(76) Inventor: David Wayne Moeller, North Kingsville, OH (US)

Correspondence Address: David Wayne Moeller, 2715 Gingertree Drive, Ashtabula, OH, 44004, US

(21) Appl. No.: 11/507,190

(22) Filed: Aug. 21, 2006

(51) Int. Cl. B27N 3/08

(52) U.S. Cl. 264/113

(57) ABSTRACT

The invention is a manufacturing process that allows solid interior and closet doors to be produced by molding wood composite materials. The doors produced will be a solid composite with decorative relief on both the face and back. The decorative relief can include both positive and negative design features and can be either simple or complex in appearance. The doors are manufactured by compressing and heating a mixture of wood or agricultural fiber and thermo-set resin between two molds. The resulting door is then removed from between the molds, trimmed to the finished size, and primed and painted. The composite used in the door can incorporate fire retardant additives to create a fire rated door. The composite in the door can be distributed so as provide for improved hinge and lockset retention.

### CROSS-REFERENCE TO RELATED APPLICATIONS

A provisional utility patent application titled Molded Composite Manufacturing Process was previously submitted.

### STATEMENT REGARDING FEDERALLY SPONSORED RESEARCH OR DEVELOPMENT

Not Applicable

### BACKGROUND OF THE INVENTION

1. Field of the Invention

The present invention relates to a molded composite manufacturing process, and more particularly to manufacturing solid core doors and other products from a material comprised of agricultural or forest byproducts and thermo-set resins. Forest byproducts that may be used in the present invention include wood, industrial wood waste, urban wood waste and agricultural byproducts such as wheat straw, soybean straw, and the like.

2. Description of Prior Art

Processes for manufacturing entry and interior doors from precisely cut and shaped pieces of wood having a decorative or relief surface are known in the prior art. This process of manufacturing a door, which uses glue and fasteners to assemble a schedule of custom made wood components together is both costly and time consuming. The assembled door is then sanded and given a protective coating.

The prior art found in Leaver's U.S. Pat. No. 629,448 issued on Jul. 25, 1899, reduced the cost of mass-producing doors by attaching door skins to a frame to produce a hollow core door with the appearance of a solid door. While the use of lower cost materials increases the overall efficiency of manufacturing doors, the process still requires an assembled frame with sufficient screw-holding capability for mounting the hinges and lock-set. Once assembled, the hollow core door is trimmed before applying the finish. It should be pointed out that a hollow core door is more subject to damage than a solid core and they do not muffle sounds as effectively as a solid door. To mitigate this deficiency, prior art such as found in Lynch, et. al. U.S. Pat. No. 5,766,774 issued on Jun. 16, 1998 and others has filled the void between the two door skins with cardboard, foam, particleboard, and other fillers, which increases the cost of the door.

There is a process for making a solid door that uses routers to cut designs into both faces from a single piece of thick medium density fiberboard (MDF) or low density fiberboard (LDF). Some manufacturers add wooden stiles to these doors to strengthen the areas where the hinges and lockset go. The door is then trimmed to size and painted to produce a unit that has the performance characteristics of a solid door. The cost of these doors is comparable to a premium filled hollow core doors.

U.S. Pat. No. 3,546,841 issued to Smith, et.al. on Dec. 15, 1970 uses compression molding of composites containing plastic to make doors. However, plastic doors are deficient in that they do not have the look and feel of a medium density fiberboard (MDF) or solid wood door. They also cost and weight more than the more conventional doors and have been known to warp and change shape dimensionally in response to changes in temperature.

In view of the foregoing disadvantages and limitations found in the prior art of manufacturing doors, there is an interest in and need for an improved process for manufacturing doors and other products that the present invention addresses.

### BRIEF SUMMARY OF THE INVENTION

The present invention is comprised of a single compression molded composite manufacturing process that uses a mixture of thermo-set resin and a forest byproduct such as wood, industrial wood waste, urban wood waste or agricultural fibers such as wheat or soybean straw to form the product. For example, a door with a relief face and back can be manufactured in one operation by compressing and heating a blend of industrial wood waste and thermo-set resins between two molds. The present invention eliminates the multiple steps found in the prior art of cutting, machining, and assembly of individual components to produce a door. It provides a means of manufacturing doors from composite material that does not contain plastic to assist in the molding process with edges of sufficient strength to support the mounting of the hinges and lockset.

Another object of the present invention is to provide a means for the compression molding of a composite interior door or another product having a depth of relief or detail that can not be achieved economically through the embossing of a previously manufactured panel. The invention also provides a means for decorative details and grain patterns without voids or surface defects that can not be machined into a solid wood or composite board product.

Another object of the present invention is to provide for the incorporation of fire retardant chemicals into the composite material so as to achieve a flame rating that meets building codes for certain types of construction projects.

The foregoing and other objects are intended to be illustrative of the invention and are not meant to establish limits. Many possible embodiments of the invention may be made and will be readily evident upon a study of the following specification and accompanying drawings comprising a part thereof. Other objects and advantages of this invention will become apparent from the following description taken in connection with the accompanying drawings, wherein is set forth by way of illustration and example, an embodiment of this invention.

### BRIEF DESCRIPTION OF THE DRAWINGS

The invention will be better understood and objects other than those set forth above will become apparent when consideration is given to the following detailed description thereof. Such description makes reference to the annexed drawing wherein:

FIG. 1 is a labeled representation of the process flow of the invention.

FIG. 2 is a drawing depicting a cross section of the molds and layers of blends inside a press and illustrates the single compression process of manufacturing a door from a mixture of thermo-set resin and a forest byproduct.

FIG. 3 is a drawing depicting a cross section of a completed door and illustrates the location of areas of the doors where additional core material has been added to improve the retention of the hinges and lockset.

### DETAILED DESCRIPTION OF THE INVENTION

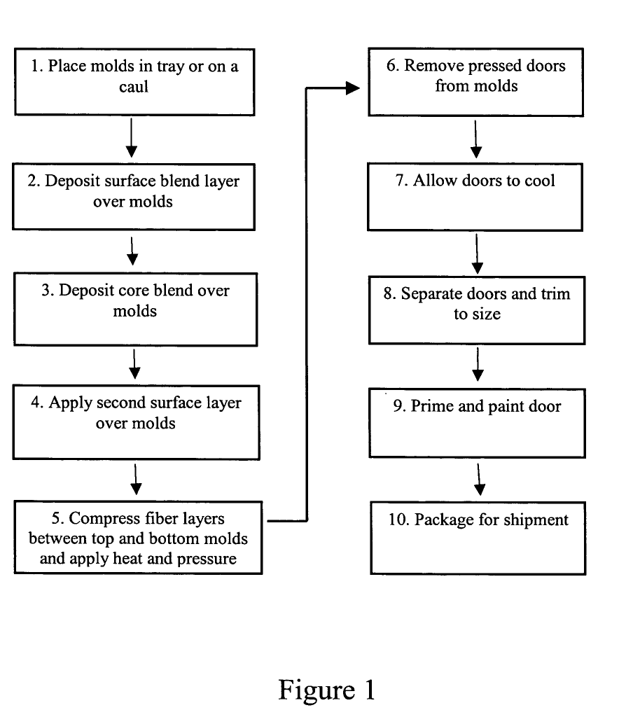

With reference to FIG. 1, preferred embodiments of the invention are illustrative of the best modes and application of the principles set forth in the following description.

FIG. 1 is a flowchart of the present invention wherein the multiple steps of cutting, machining, and assembly presently required to manufacture a solid wood or hollow core door are reduced to one operation. The invention embodies the manufacturing process of compressing and heating a mixture of wood or agricultural waste and thermo-set resins between two molds to produce a door with all of the performance characteristics of one made of solid wood.

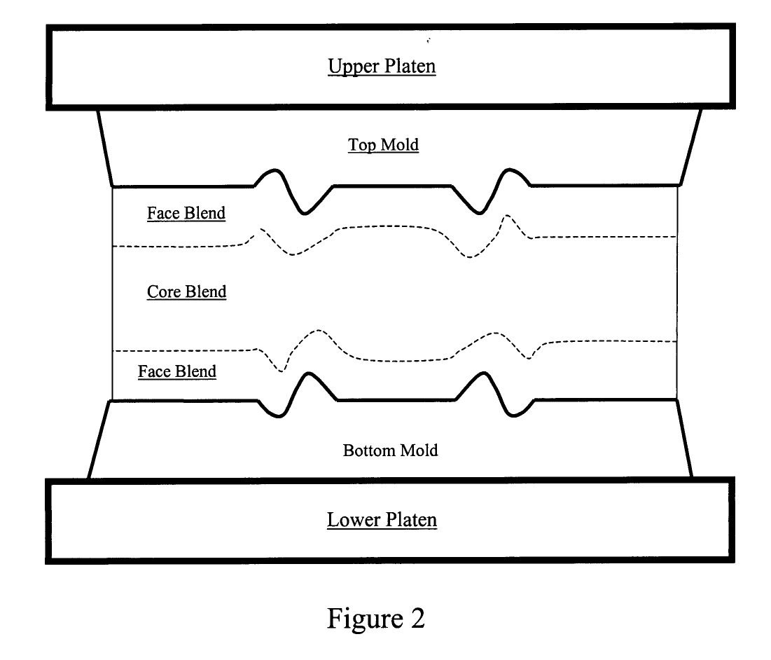

With reference to FIG. 1, Step 1, the first embodiment of the invention is to place the molds in a tray or on a caul so that they can be transported under the feeders on their way to the press. The molds pass under the first feeder, Step 2, where a face blend comprised of fine wood particles and resin is deposited in a uniform layer over the mold surface. The molds then move to the second feeder wherein a core blend (a mixture of coarser wood particles and resin) is deposited, Step 3, either uniformly over the surface layer or with additional material added to specific areas to strengthen the perimeter of the door for hinge and lockset retention. Having completed Step 3, the assembly moves to a third feeder, Step 4, where the top face layer is added to form a three layer mat. The assembly then moves to the heated press Step 5, where the layers are compressed to the thickness of the finished product between the top and bottom molds. As illustrated in FIG. 2, the heated press is closed thereby bonding the resins and wood fiber to form a solid composite panel. The panel is removed from the molds, Step 6, and allowed to cool in Step 7. Each door is then trimmed to size, Step 8, and primed and painted, Step 9, before being packaged for shipment in Step 10.

In another embodiment of the invention, commercially available fire-retardant chemicals, typically mineral salts, are added to the composite to produce a fire rated door.

Although detailed embodiments of the present invention are disclosed herein; it is to be understood that the disclosed embodiments are merely exemplary of the invention, which may be embodied in other forms. Therefore, specific structural and functional details disclosed herein are not to be interpreted as limiting, but merely as a basis for the claims. It is also a representative basis for teaching one skilled in the art to employ the present invention in any appropriately detailed structure.

With reference to FIG. 2, the invention heats and compresses a mixture of fiber processed from wood (virgin wood or industrial wood waste or urban wood waste) or an agricultural byproduct such as wheat straw and a resin between two molds to produce a composite door. The face and back of a door, which may contain a wood grain patterns, projected detail or some other relief can be painted or given a powder coat finish and the like.

Fibers used in the manufacturing process may be comprised of wood (virgin wood or industrial wood waste or urban wood waste) or an agricultural fiber such as wheat straw. The said fiber is first dried with heated air in a purpose-built dryer to a moisture content of 5-8% when mixed with spray dried resins and 2-4% with liquid resins. It is then pulverized in a hammermill and passed through a set of screens that sort it into three sizes (face fiber that will pass through a fine-mesh screen, core fiber which will pass through a coarse-mesh screen, and oversize material that will not pass through a coarse-mesh screen). All oversize material is run back through the hammermill to be further reduced in size.

Material that is used to form the front and back of a door is comprised of face fiber mixed with ten to sixty percent (10-60%) resin by weight to attain a specific level of surface hardness and durability. These resins include spray dried melamine-formaldehyde resin or urea-formaldehyde resin or phenol-formaldehyde resin or the like. It is common practice to add a small amount of zinc sterate (typically less than 1%) to the face blend to improve the release characteristics of the mold. Between 0.35 and 1.05 lbs./sq. ft. of face blend is required in Step 2 and 4 of FIG. 1 to form the front and back of the door. Half of it is used for the bottom layer and the other half for the top layer.

The core blend used in the manufacturing process is comprised of eighty to ninety five percent (80-95%) core fiber by weight mixed with five to twenty percent (5-20%) spray dried or liquid urea-formaldehyde resin, phenol-formaldehyde resin or diphenylmethane diisocyanate resin (MDI). It should be noted that varying the ratio of resin to core fiber changes the performance characteristics of the product. Also, adding a small amount of wax emulsion or slack wax (typically 1-2%) will increase the materials resistance to moisture. It takes between 1.5 and 6.0 lbs./sq. ft. of core blend, depending on the thickness and density of the finished product, to form Step 3, the core layer.

After the mold has been covered with the face blend, the core blend, and any additional material, FIG. 1, Steps 2 and 3, the composite may be consolidated by a prepressing the layers. Pre-pressing consolidates the mat and allows the second face layer to be added with only a small portion of the face blend being lost within the core blend layer. Pre-pressing also stabilizes the layers so the molds and mat can be moved to the press without the blends being redistributed by the vibration or motion associated with transport.

With reference to FIG. 1, the molded composite manufacturing process is now described in detail. Step 1 places the molds in trays or on cauls where their surfaces may be treated with a commercial release agent to keep the blended material from sticking to the mold. The molds, which are made of aluminum, resin or steel, have a relief that leaves an image in the compression molded composite interior door. In Step 2, a measure of blended material comprised of fine wood fiber and resin is deposited over the mold to form the face layer or face relief portion of the door. As previously stated, the amount of material to be deposited is adjusted for the depth of relief in the mold.

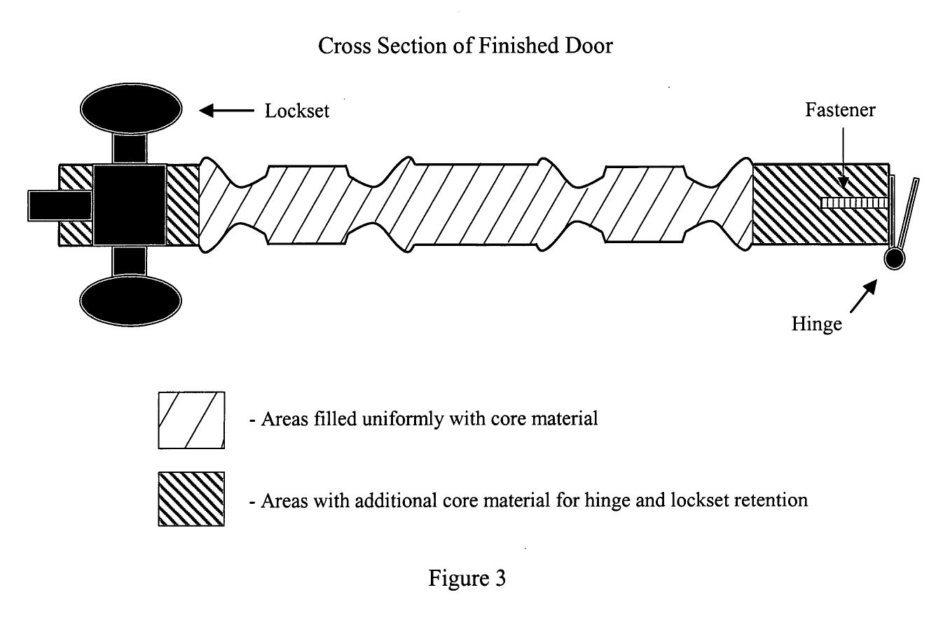

Having completed Step 2 of FIG. 1, proceed to Step 3 in which the core blend is placed over the face layer. The amount of material used to form the core layer is determined by the thickness and density of the finished interior door. Additional core blend may be added in Step 3 to strengthen localized areas for the mounting of hinges and a lockset (FIG. 3 shows the location of these strengthened areas). Having completed Step 3, the two layers may be pre-pressed to consolidate them. The manufacturing process then moves to Step 4 of said flow diagram, where a second layer of face blend is placed on top of the core layer to form the back relief of the door.

In Step 5 of FIG. 1, the top mold, which is attached to the upper platen of the press, is lowered into position as illustrated in FIG. 2 thereby covering the layers. Molds, which have a relief, will leave an imprint of their design on the back surface of the door. The bottom molds containing the layers of blend rest on the lower platen in a position so as to align the back of the door with the front. The press, comprised of the upper and lower platens, FIG. 2, is closed and the layers of blend are heated, to a temperature of 220° F. to 410° F., while a force of 300 to 900 psi compresses them between the two molds. Factors that effect the amount of force that is applied to the layers include the door design, resin percentage, moisture content of the fiber and density of the material. The temperature and cure time is adjusted to compensate for the resin used, moisture content and thickness of the material. Pressure on the mold is maintained from four to fifteen (4-15) minutes. Factors that effect the length of cure time include the type of resin, temperature of the press, material density, and thickness of the product being produced.

At the completion of Step 5, the assembly FIG. 2, is removed from the press and Step 6 is then performed to remove the doors from the molds and tray. When they have cooled in Step 7 of FIG. 1, the doors are separated and trimmed to size Step 8, wherein excess material is removed from the perimeter of the doors. Some common sizes of doors are 24″, 30″, 32″, or 36″ wide by 78″ or 80″ high.

The correctly sized doors from Step 8 move to Step 9 where they are sprayed or roll coated with a commercially available primer to prepare them for painting or they may be powder coated. The molded composite manufacturing process is completed in Step 10, wherein the finished product is packaged for shipment.

In the foregoing description, certain terms have been used for brevity, clearness and understanding. All equivalent relationships to those illustrated in the drawings and described in the preferred embodiment are to be encompassed by this present invention to produce the intended results. It is also to be understood that the following claims are intended to cover all of the generic and specific features of the invention herein described, and all statements of the scope of the invention which, as a matter of language, might be said to fall there between.

Having thus described and disclosed preferred embodiment of my invention, what I claim as my invention is:

1. A molded composite manufacturing process for producing solid core doors comprising:
a compression method of forming said doors between two molds using a composite material comprised of a mixture of agricultural or forest byproducts and thermo-set resins,
a first face layer comprised of 10% to 60% by weight of melamine-formaldehyde resin and 40% to 90% by weight of wood fiber, said material a means to form a face layer within a mold having at least one surface containing relief patterns,
a core layer of composite material covering a face layer comprised of 5% to 20% by weight urea-formaldehyde resin and 80% to 95% by weight wood fiber,
a second face layer comprised of 10% to 60% by weight of melamine-formaldehyde resin and 40% to 90% by weight of wood fiber,
a second mold placed over the first to encapsulate and compress the layers of composite material,
heating of layers in said molds to 210° F. to 410° F., and compressing said mixture between said molds at a pressure of less than 1000 psi.

2. A process in accordance with claim 1, wherein said wood fiber is agricultural fiber.

3. A process in accordance with claim 1, wherein said melamine-formaldehyde resin is phenol-formaldehyde resin.

4. A process in accordance with claim 1, wherein said melamine-formaldehyde resin is urea-formaldehyde resin.

5. A process in accordance with claim 1, wherein said urea-formaldehyde resin is phenol-formaldehyde resin.

6. A process in accordance with claim 1, wherein said urea-formaldehyde resin is MDI resin.

7. A process in accordance with claim 1, wherein said urea-formaldehyde resin is melamine-formaldehyde resin.

8. A process in accordance with claim 1, wherein additional said core layer is placed over specific areas of said mold to increase door strength for hinge and lockset retention.

9. A process in accordance with claim 1, wherein fire retardant chemicals are added to the face and core layers to produce a fire rated door.
